(19) United States
(12) Patent Application Publication
(10) Pub. No.: US 2024/0429543 A1
(43) Pub. Date: Dec. 26, 2024

(54) HEADER APPARATUS

(71) Applicant: Rivian IP Holdings, LLC, Irvine, CA (US)

(72) Inventors: Casey Taylor Dunn, Mission Viejo, CA (US); Brandon Thayer, Mission Viejo, CA (US); Michael Ryan Tillapaugh, Rancho Mission Viejo, CA (US); Andrew Robert Krasts, San Clemente, CA (US)

(21) Appl. No.: 18/341,187

(22) Filed: Jun. 26, 2023

(51) Int. Cl. H01M 50/298; H01M 50/262; H01M 50/271; H01M 50/503; H01M 50/517

(52) U.S. Cl. CPC H01M 50/298; H01M 50/262; H01M 50/271; H01M 50/503; H01M 50/517; H01M 50/249; H01M 2220/20

(57) ABSTRACT

An apparatus can include a plate that can couple with a non-conductive header of a battery pack. The plate can form a conductive path between the header and the battery pack.

A variety of systems can include one or more connectors to facilitate coupling electrical components together. For example, a connector can couple with an enclosure of a battery pack.

### SUMMARY

Generally, electrical connectors connect to an electrical grounding path. Systems and methods described herein can provide a grounding path for one or more headers of a battery pack in a vehicle. For example, a header apparatus can include a plate that can couple with one or more headers of a battery pack. The plate can form a conductive path to provide a grounding path between the header and the battery pack. The battery pack can be grounded with another portion of a vehicle (e.g., the chassis) to facilitate grounding the header with the chassis of the vehicle. The header apparatus can facilitate providing a grounding path for one or more headers even when the battery pack, or other battery enclosures, includes a non-conductive coating applied to a portion of the battery pack.

At least one aspect is directed to an apparatus. The apparatus can include a plate that can couple with a non-conductive header of a battery pack. The plate can form a conductive path between the header and the battery pack.

At least one aspect is directed to a battery pack. The battery pack can include an apparatus. The apparatus can include a plate that can couple with a non-conductive header of the battery pack. The plate can form a conductive path between the header and the battery pack.

At least one aspect is directed to a method. The method can include coupling a plate with a non-conductive header of a battery pack. The method can include forming, by the plate, a conductive path between the header and the battery pack.

At least one aspect is directed to an electric vehicle. The electric vehicle can include a battery pack. The battery pack can include an apparatus. The apparatus can include a plate that can couple with a non-conductive header of the battery pack. The plate can form a conductive path between the header and the battery pack.

These and other aspects and implementations are discussed in detail below. The foregoing information and the following detailed description include illustrative examples of various aspects and implementations, and provide an overview or framework for understanding the nature and character of the claimed aspects and implementations. The drawings provide illustration and a further understanding of the various aspects and implementations, and are incorporated in and constitute a part of this specification. The foregoing information and the following detailed description and drawings include illustrative examples and should not be considered as limiting.

### BRIEF DESCRIPTION OF THE DRAWINGS

The accompanying drawings are not intended to be drawn to scale. Like reference numbers and designations in the various drawings indicate like elements. For purposes of clarity, not every component may be labeled in every drawing. In the drawings:

FIG. 1 depicts an example electric vehicle, in accordance with implementations.

FIG. 2 depicts an example battery pack, in accordance with implementations.

FIG. 3 depicts an example perspective view of a portion of a header apparatus of the battery pack of FIG. 2, in accordance with implementations.

FIG. 4 depicts an example perspective view of a portion of the header apparatus of FIG. 3, in accordance with implementations.

FIG. 5 depicts an example perspective view of the header apparatus of FIG. 3, in accordance with implementations.

FIG. 6 depicts an example detailed perspective view of a portion of the header apparatus of FIG. 3, in accordance with implementations.

FIG. 7 depicts an example perspective view of the header apparatus of FIG. 3 coupled with the battery pack, in accordance with implementations.

FIG. 8 depicts an example perspective view of a portion of a header apparatus of the battery pack of FIG. 2, in accordance with implementations.

FIG. 9 depicts an example perspective sectional view of a portion of the header apparatus of FIG. 8, in accordance with implementations.

FIG. 10 depicts an example perspective view of a portion of the header apparatus of FIG. 8, in accordance with implementations.

FIG. 11 depicts an example perspective view of a portion of the header apparatus of FIG. 8, in accordance with implementations.

FIG. 12 depicts an example detailed perspective view of a portion of the header apparatus of FIG. 8, in accordance with implementations.

FIG. 13 depicts an example illustration of a process, in accordance with implementations.

FIG. 14 depicts an example illustration of a process, in accordance with implementations.

### DETAILED DESCRIPTION

Following below are more detailed descriptions of various concepts related to, and implementations of, methods, apparatuses, and systems of a header apparatus that facilitates grounding a header of a batter pack with another portion of a vehicle. The various concepts introduced above and discussed in greater detail below may be implemented in any of numerous ways.

The present disclosure is directed to systems and methods of providing a grounding path for one or more headers of a battery pack in a vehicle. For example, a header apparatus can include a plate that can couple with one or more headers of a battery pack. The plate can couple with a conductive path to provide a grounding path between the header and the battery pack. The battery pack can be grounded with another portion of a vehicle (e.g., the chassis) to facilitate grounding the header with the chassis of the vehicle. The header apparatus can facilitate providing a grounding path for one or more headers even when the battery pack, or other enclosures, includes a non-conductive coating applied to a portion of the battery pack.

The disclosed solutions have a technical advantage of providing a grounding path for one or more headers even when a battery pack has a non-conductive coating (e.g., E-coating) applied to a housing of the battery pack. For example, a battery pack enclosure for an electric vehicle can include an outer layer of E-coating or powder coating that results in electrical isolation (e.g., no grounding path) between the enclosure and a header coupled with the enclosure. The disclosed solutions have a technical advantage of providing an electrical connection without interfering with a seal of the header. Further, the disclosed solutions can reduce or eliminate the need for pre-or post-processing of the enclosure to clear the coating. This can result in reduced process complexity, while still providing a reliable solution.

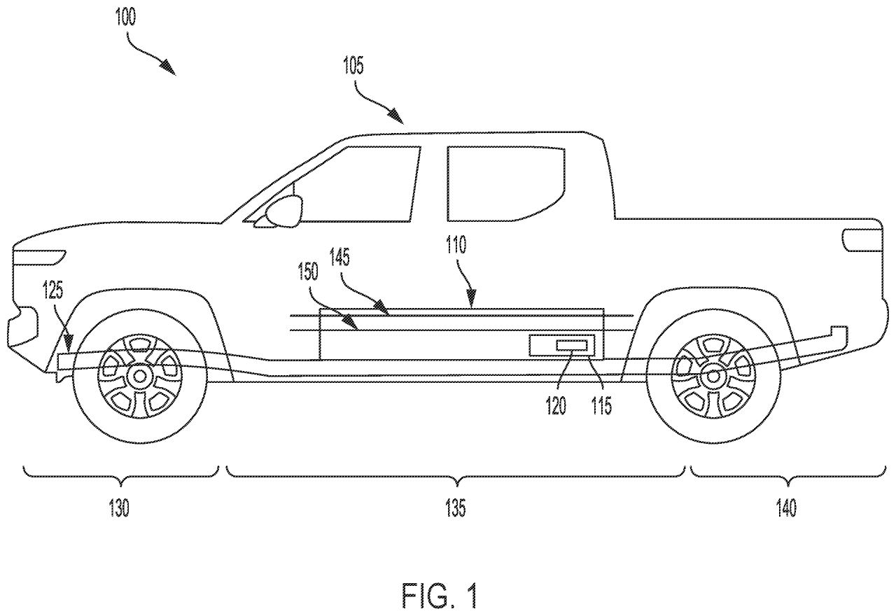

FIG. 1 depicts an example cross-sectional view 100 of an electric vehicle 105 installed with at least one battery pack 110. Electric vehicles 105 can include electric trucks, electric sport utility vehicles (SUVs), electric delivery vans, electric automobiles, electric cars, electric motorcycles, electric scooters, electric passenger vehicles, electric passenger or commercial trucks, hybrid vehicles, or other vehicles such as sea or air transport vehicles, planes, helicopters, submarines, boats, or drones, among other possibilities. The battery pack 110 can also be used as an energy storage system to power a building, such as a residential home or commercial building. Electric vehicles 105 can be fully electric or partially electric (e.g., plug-in hybrid) and further, electric vehicles 105 can be fully autonomous, partially autonomous, or unmanned. Electric vehicles 105 can also be human operated or non-autonomous. Electric vehicles 105 such as electric trucks or automobiles can include on-board battery packs 110, batteries 115 or battery modules 115, or battery cells 120 to power the electric vehicles. The electric vehicle 105 can include a chassis 125 (e.g., a frame, internal frame, or support structure). The chassis 125 can support various components of the electric vehicle 105. The chassis 125 can span a front portion 130 (e.g., a hood or bonnet portion), a body portion 135, and a rear portion 140 (e.g., a trunk, payload, or boot portion) of the electric vehicle 105. The battery pack 110 can be installed or placed within the electric vehicle 105. For example, the battery pack 110 can be installed on the chassis 125 of the electric vehicle 105 within one or more of the front portion 130, the body portion 135, or the rear portion 140. The battery pack 110 can include or connect with at least one busbar, e.g., a current collector element. For example, the first busbar 145 and the second busbar 150 can include electrically conductive material to connect or otherwise electrically couple the battery 115, the battery modules 115, or the battery cells 120 with other electrical components of the electric vehicle 105 to provide electrical power to various systems or components of the electric vehicle 105.

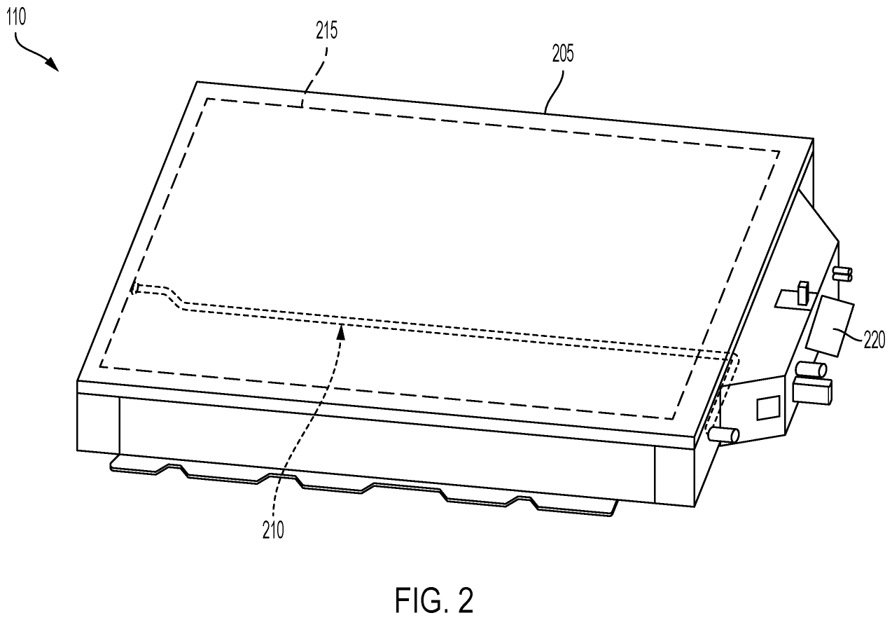

FIG. 2 depicts an example battery pack 110. Referring to FIG. 2, among others, the battery pack 110 can provide power to electric vehicle 105. Battery packs 110 can include any arrangement or network of electrical, electronic, mechanical or electromechanical devices to power a vehicle of any type, such as the electric vehicle 105. The battery pack 110 can include at least one housing 205. The housing 205 can include at least one battery module 115 or at least one battery cell 120, as well as other battery pack components. The battery module 115 can be or can include one or more groups of prismatic cells, cylindrical cells, pouch cells, or other form factors of battery cells 120. The housing 205 can include a shield on the bottom or underneath the battery module 115 to protect the battery module 115 and/or cells 120 from external conditions, for example if the electric vehicle 105 is driven over rough terrains (e.g., off-road, trenches, rocks, etc.) The battery pack 110 can include at least one cooling line 210 that can distribute fluid through the battery pack 110 as part of a thermal/temperature control or heat exchange system that can also include at least one thermal component (e.g., cold plate) 215. The thermal component 215 can be positioned in relation to a top submodule and a bottom submodule, such as in between the top and bottom submodules, among other possibilities. The battery pack 110 can include any number of thermal components 215. For example, there can be one or more thermal components 215 per battery pack 110, or per battery module 115. At least one cooling line 210 can be coupled with, part of, or independent from the thermal component 215.

The battery modules 115 can each include a plurality of battery cells 120. The battery modules 115 can be disposed within the housing 205 of the battery pack 110. The battery modules 115 can include battery cells 120 that are cylindrical cells or prismatic cells, for example. The battery module 115 can operate as a modular unit of battery cells 120. For example, a battery module 115 can collect current or electrical power from the battery cells 120 that are included in the battery module 115 and can provide the current or electrical power as output from the battery pack 110. The battery pack 110 can include any number of battery modules 115. For example, the battery pack can have one, two, three, four, five, six, seven, eight, nine, ten, eleven, twelve or other number of battery modules 115 disposed in the housing 205. It should also be noted that each battery module 115 may include a top submodule and a bottom submodule, possibly with a thermal component 215 in between the top submodule and the bottom submodule. The battery pack 110 can include or define a plurality of areas for positioning of the battery module 115 and/or cells 120. The battery modules 115 can be square, rectangular, circular, triangular, symmetrical, or asymmetrical. In some examples, battery modules 115 may be different shapes, such that some battery modules 115 are rectangular but other battery modules 115 are square shaped, among other possibilities. The battery module 115 can include or define a plurality of slots, holders, or containers for a plurality of battery cells 120. It should be noted the illustrations and descriptions herein are provided for example purposes and should not be interpreted as limiting. For example, the battery cells 120 can be inserted in the battery pack 110 without battery modules and. The battery cells 120 can be disposed in the battery pack 110 in a cell-to-pack configuration without modules and, among other possibilities. Battery cells 120 have a variety of form factors, shapes, or sizes. For example, battery cells 120 can have a cylindrical, rectangular, square, cubic, flat, pouch, elongated or prismatic form factor.

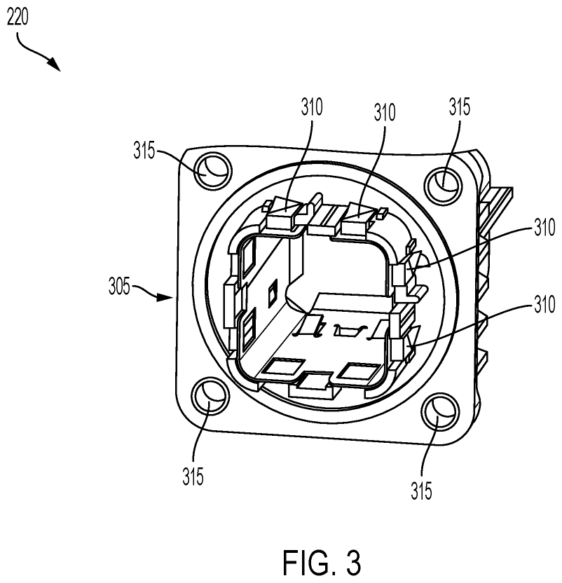

FIG. 3 depicts an example perspective view of a portion of an apparatus 220, according to an example implementation. The apparatus 220 can be a header apparatus 220 (e.g., a connector apparatus). For example, the header apparatus 220 can he or include one or more headers 305 (e.g., connectors, plugs, or receptacles) capable of coupling one or more components (e.g., cables, busbars, or other components) with a high voltage (“HV”) or high electrical interference system. The header apparatus 220 can facilitate coupling one or more electrical components of the vehicle 105 (e.g., a drive unit, an inverter, a motor, an air conditioning unit, a heater, an AC charger, or other electrical components) with one or more components of the battery pack 110 (e.g., a battery management system (“BMS”), the battery cells, or another component) such that electrical current or signals can flow between a component of the battery pack 110 and one or more electrical components of the vehicle 105 disposed outside of the battery pack housing 205. For example, the header apparatus 220 can couple with a portion of the housing 205 of the battery pack 110 such that at least a portion of the header apparatus 220 is exposed to an area exterior to the battery pack housing 205, as shown in at least FIG. 2.

The header apparatus 220 can include or can couple with one or more portions interior to the battery pack housing 205 (e.g., the header apparatus 220 can extend within an internal portion of the battery pack housing 205). The header apparatus 220 can couple with various other systems or appliances. For example, the header apparatus 220 can couple one or more electrical components with an inverter, a compressor (e.g., an alternating current “AC” compressor), a heater, or another device. As an example, the header apparatus 220 can couple with any device that uses a shielded cable or enclosure (e.g., an electrical cable enclosed by one or more insulated layers, a component having a faraday shield, a component having a coated exterior (e.g., a non-conductive coating), or another component). The header apparatus 220 can couple with a front wall of the battery pack 110 (e.g., a wall closest to the front portion 130 of the vehicle 105).

In particular, FIG. 3 depicts a perspective view of a header 305 of the apparatus 220. The header 305 can include one or more non-metallic materials that form the header 305. For example, the header 305 can be formed from one or more materials including, but not limited to, plastics (e.g., polyamide, nylon, polyamide 66 (“PA66”), polymer, polybutylene terephthalate (“PBT”), acrylonitrile butadiene styrene (“ABS”), polycarbonate (“PC”), polyethylene (“PE”), polypropylene (“PP”), polyethylene terephthalate (“PETE”), polyvinyl chloride (“PVC”), or other plastics), or other non-metallic materials. The header 305 can be formed in a variety of ways including, but not limited to, molding (e.g., injection molding, compression molding, or other forms of molding), extrusion, subtractive manufacturing, additive manufacturing (e.g., 3D printing), or other types of manufacturing. The header 305 can be or can include at least one external layer (e.g., a layer exposed to an external portion of the battery pack housing 205) at least partially formed of a non-conductive material. At least a portion of the external layer can include a conductive material, as described herein.

The header 305 can include one or more metallic materials or other at least partially conductive materials. For example, the header 305 can include at least one spring feature 310. The spring features 310 can be or can include one or more conductive materials that protrude or bias at least partially outward from the header 305. The spring features 310 can be monolithically formed with the header 305, or the spring features 310 can be independently formed and coupled with the header 305 in various ways (e.g., via welding, fasteners, adhesives, etc.). The header 305 can include a plurality of spring features 310 (e.g., two features 310, three features 310, four features 310, five features 310, six features 310, or more features 310). The spring features 310 may not have a spring-like effect (e.g., biasing effect), or the spring features 310 can be biased outwards from the header 305. For example, the spring features 310 can include a stamped shielding piece that can spring out away from the header 305. As described herein, the spring features 310 can contact a portion of a plate to couple with and form a conductive pathway to facilitate grounding the header 305 with another portion of the vehicle 105.

The header 305 can include at least one aperture 315 (e.g., hole, slot, opening, or other component) that can receive a fastener. For example, the header 305 can include one or more through holes (apertures 315). The header 305 can include any amount of through holes. For example, the header 305 can include four through holes. The header 305 can include four through holes each positioned along a top surface of the header 305. At least one through hole (e.g., aperture 315) can receive a fastener. For example, each through hole can receive a fastener. The fasteners can facilitate coupling the header 305 with a portion of a battery pack 110.

The header 305 can include at least one compression limiter. The compression limiter can be or can include one or more materials coupled with, or integrally formed with, the header 305 to facilitate strengthening the header 305. For example, the compression limiter can include at least one material that extends within a portion of a through hole (e.g., aperture 315) to support the geometry of the through hole. The compression limiter can facilitate receiving a load (e.g., a compression load) applied to one or more portions of the apparatus 220, such as the header 305, to support the structural integrity of the header 305. For example, the compression limiter can include at least one material that surrounds a portion of an inner diameter of an aperture 315 of the header 305. The compression limiter can include material that surrounds an entire inner diameter of the aperture 315, as an example. The compression limiter can include one or more portions that can receive, abut, contact, or otherwise position near to one or more fasteners. The compression limiter can surround a portion of the through holes such that the compression limiter facilitates maintaining the structural integrity of the through hole when a compression load is applied to the through hole (e.g., by the fastener).

The compression limiter can include one or more conductive materials. For example, the compression limiter can be formed from one or more metals (e.g., steel, aluminum, brass, or other metals). The compression limiter can include a conductive material such that a conductive path can be formed with one or more portions of the compression limiter. For example, the compression limiter can include one or more materials that allow a path for current to flow when in contact with another conductive material. As an example, the compression limiter can include one or more metals coupled with one or more plastic portions of the header 305.

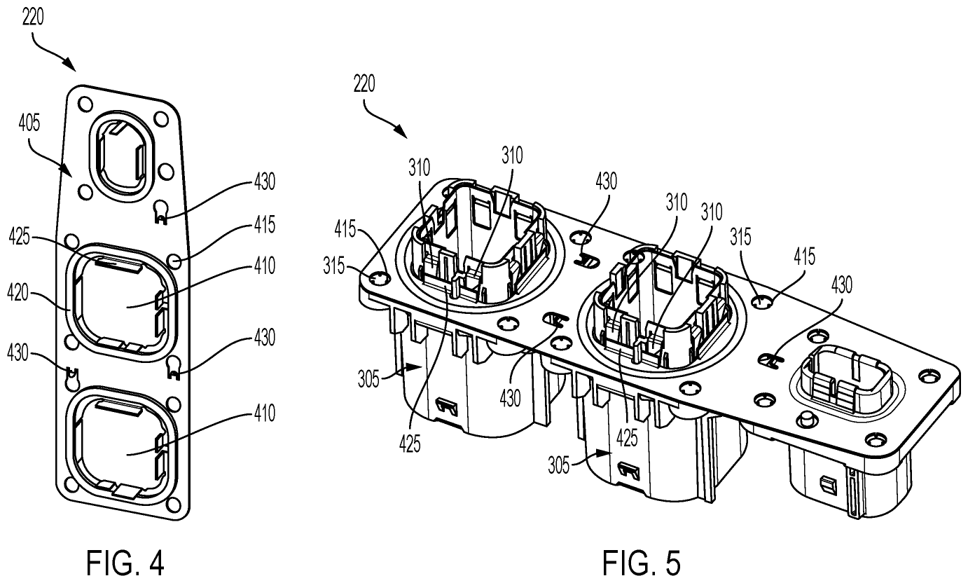

FIG. 4 depicts an example perspective view of a portion of the apparatus 220. For example, FIG. 4 depicts a perspective view of a plate 405. The plate 405 can couple with a header 305 of the battery pack 110, or with another enclosure. The plate 405 can couple with and form a conductive path (e.g., a protrusion 425 or a piercing element 430 described herein) between the header 305 and the battery pack 110. For example, the plate 405 can be or can include one or more conductive materials. For example, the plate 405 can be made of one or more metals (e.g., aluminum, steel, etc.). The plate 405 can include at least one slot 410 (e.g., hole, aperture, etc.) that can at least partially receive a header 305. For example, as depicted in FIG. 5, the plate 405 can couple with one or more headers 305 (e.g., two headers 305, three headers 305, or more headers 305).

The plate 405 can include at least one aperture 415 (e.g., hole, opening, etc.) that can receive a fastener to facilitate coupling the header 305 with the plate 405. For example, the one or more apertures 415 of the plate 405 can align with at least one aperture 415 of a header 305 to receive a fastener extending through the header 305 and couple the header 305 to the plate 405. The plate 405 can include at least one gasket 420. For example, each slot 410 can include a gasket 420 (e.g., a die cut gasket) that at least partially surrounds the slot 410 and facilitates sealing the header 305 with the housing 205 of the battery pack 110. The gaskets 420 can include an adhesive backing to facilitate forming a seal of the header 305 with the housing 205 of the battery pack 110. For example, the gaskets 420 can be positioned to couple between the header 305 or plate and the battery pack 110 such that the gasket 420 at least partially engages the battery pack housing 205 (e.g., when a fastener extending through the apertures 315, 415 connects to the battery pack 110 and facilitates compressing the gasket 420 between the plate 405 and the battery pack 110). The plate 405 can include at least one gasket 420 positioned at or near a location of a seal of each respective header 305.

The plate 405 can include at least one conductive feature that facilitates coupling the header 305. For example, the plate 405 can include at least one protrusion 425 at or near the slot 410. The protrusion 425 can be formed of at least one conductive material (e.g., metals such as aluminum or steel). The protrusion 425 can be monolithically formed with the plate 405, or the protrusion 425 can connect to the plate 405 in various ways (e.g., welding, adhesives, etc.). The protrusion 425 can extend from a surface of the plate 405. For example, the protrusion 425 can extend from the plate 405 to engage (e.g., contact) at least a portion of at least one of the spring features 310 of the header 305 to form a conductive pathway between the spring features 310 and the plate 405 (e.g., via contact between the spring features 310 and the protrusion 425). For example, the protrusion 425 can establish an electrical connection with the spring feature 310 such that electrical current can flow between the spring feature 310 and the protrusion 425.

The plate 405 can include at least one piercing element 430 that at least partially extends beyond a non-conductive coating of a battery pack 110. For example, the piercing element 430 can facilitate at least partially piercing (e.g., cutting, breaking through, digging) through at least a portion of a coating of the housing 205 of the battery pack 110. The piercing element 430 can be a protrusion or extension of the plate 405 that at least partially extends away from a surface of the plate 405. For example, the piercing elements 430 can be formed by cutting away at least a portion of material of the plate 405 and bending a portion of the plate 405 away from the plate 405. The one or more piercing elements 430 can each extend in the same direction away from the plate 405 or the piercing elements 430 can extend in opposing directions. The piercing elements 430 can include at least one sharp edge (e.g., a pointed edge, a triangular edge, a tooth-like edge, a serrated edge, a saw tooth edge, etc.). The sharp edge of the piercing elements 430 can facilitate piercing at least a portion of the battery pack 110, as described herein. The plate 405 can include any amount of piercing elements 430. For example, the plate 405 can include one piercing clement 430, two piercing elements 430 (e.g., one positioned near each header 305), or more or less piercing elements 430).

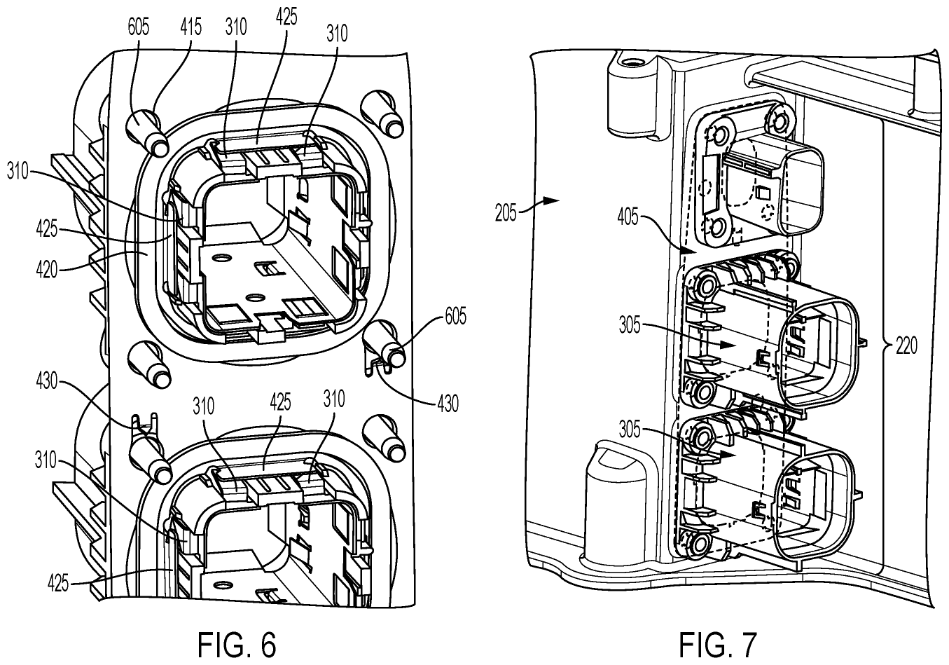

FIG. 6 depicts an example perspective view of the plate 405 and headers 305 and FIG. 7 depicts the plate 405 and headers 305 coupled with the battery pack housing 205. For example, the plate 405 can couple with the battery pack housing 205 via one or more fasteners 605. The fasteners 605 can extend at least partially through a header 305 (e.g., via an aperture 315), through the plate 405 (e.g., via an aperture 415), and into a portion of the battery pack 110. At least one fastener 605 can contact a compression limiter coupled with an aperture 315 of the header 305. For example, a fastener 605 can facilitate forming a conductive pathway between the compression limiter and the battery pack 110 (e.g., the fastener 605 can be a cutting fastener that contacts at least a portion of the compression limiter and cuts into a portion of the battery pack 110).

The battery pack 110 can include an at least partially non-conductive coating that covers at least a portion (up to an entirety) of the battery pack housing 205. The non-conductive coating can be or include, for example, E-coating, powder coating, paint, or other coats applied to the housing 205 that include at least one non-conductive material. The non-conductive coating can be various thicknesses (e.g., between 5 microns and 100 microns in thickness). The non-conductive coating can be more or less thick. The piercing elements 430 of the plate 405 can facilitate scraping, piercing, cutting away, or protruding through at least a portion of the non-conductive coating of the housing 205 such that the piercing elements 430 can at least partially contact a conductive portion of the housing 205 (e.g., walls of the housing 205 underneath one or more layers of the non-conductive coating). For example, the plate 405 or header 305 can couple with a front wall of the housing 205 of the battery pack 110 (e.g., with a wall closest in position to the front portion 130 of the vehicle 105 relative to the rest of the housing 205). With this configuration, the header 305 and the battery pack 110 can form a conductive (e.g., grounding) pathway (e.g., a pathway for electrical current to flow between conductive materials). For example, the pathway can extend from at least one spring feature 310 of the header 305, to at least one protrusion 425 of the plate 405 in contact with the at least one spring feature 310, to at least one piercing element 430, and to the conductive portion of the housing 205 of the battery pack 110 (e.g., beneath the non-conductive coating).

The housing 205 can be conductively connected (e.g., grounded) with another portion of the vehicle 105, such as the chassis 125, to continue the conductive pathway. In other words, the spring features 310, the protrusions 425, and the piercing elements 430 can facilitate grounding a header 305 with a chassis 125 of the vehicle 105. The one or more fasteners 605 extending through the header 305 and plate 405 can further facilitate forming the conductive pathway via contact between the fastener 605 and a compression limiter coupled with the header 305 when the fastener 605 connects with the housing 205 of the battery pack 110 (e.g., when the fastener 605 cuts away at least a portion of the coating of the battery pack 110). In some implementations, the plate 405 (e.g., the piercing element 430) or another portion of the apparatus 220 can contact a portion of the chassis 125 of the vehicle 105 directly (e.g., with or without contacting the housing 205 of the battery pack 110).

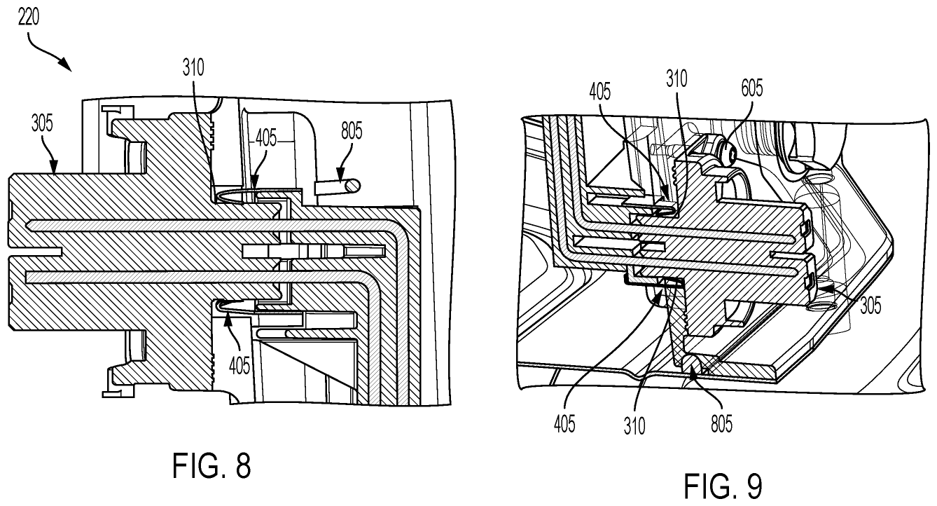

FIGS. 8 and 9 depict sectional views of the header apparatus 220, according to an example implementation. The plate 405 can couple with an external portion of a header 305. For example, the plate 405 can be a tab that at least partially surrounds and protrudes towards the header 305. That plate 405 can at least partially receive a header 305. The plate 405 can include at least a portion that biases towards or protrudes towards a portion of the header 305 (e.g., the spring features 310) to at least partially contact the spring features 310. For example, the plate 405 can include at least one conductive material that contacts at least one spring feature 310 (e.g., made at least partially of conductive material) of a header 305 to facilitate forming a conductive pathway. The plate 405 can be or can include an overmolded material of a busbar. For example, at least a portion of the plate 405 can be or can include a conductive sheet of material.

The plate 405 at least partially surrounding the header 305 and at least partially protruding towards and contacting a spring feature 310 can couple with (e.g., contact) at least one conductive pathway (e.g., line 805). For example, the conductive line 805 can be or include a wire, cable, or other line formed of a conductive material. The line 805 can couple with the plate 405 in various ways including, but not limited to, welding, fasteners, conductive adhesives, or other means. The tab (e.g., plate 405) can at least partially couple with one or more busbars. For example, the line 805 can be a ground neutral (GND) wire or overmolded ground busbar that connects to the header 305.

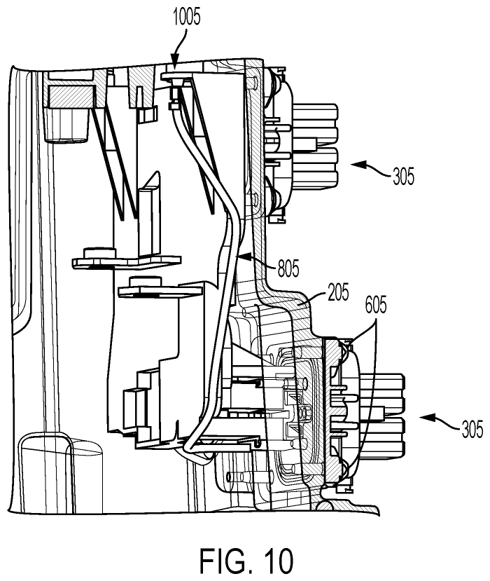

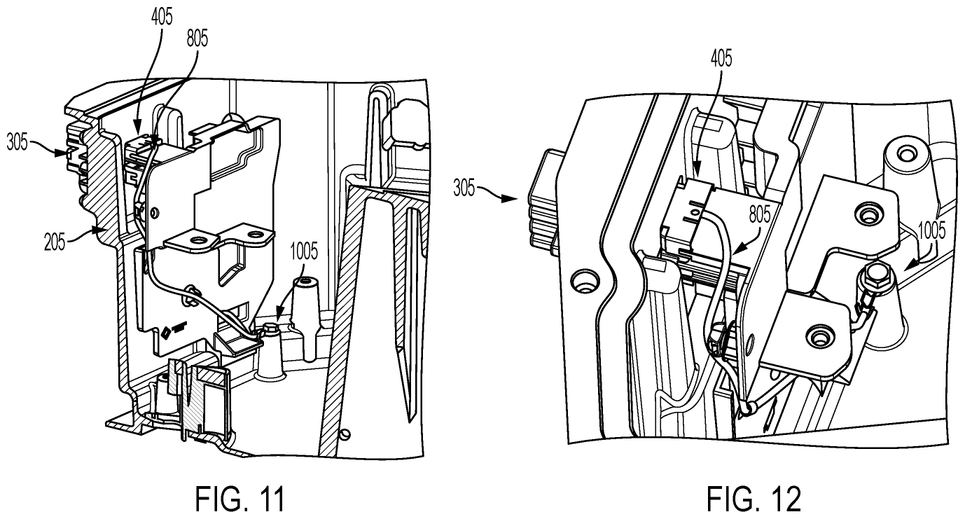

FIGS. 10 and 11 depict perspective views of the header apparatus 220 from an inner portion of the housing 205 of the battery pack 110. FIG. 12 depicts a detailed perspective view of the header apparatus 220 from an inner portion of the housing 205. As depicted, the line 805 can couple with a fastener 1005 (e.g., via welding or other means) such that the line 805 at least partially contacts the fastener 1005. The fastener 1005 can be or include a cutting fastener (e.g., screw), bolt, clip, tab, clamp, or other feature that can couple with a portion of the battery pack 110. The fastener 1005 can include at least one conductive material. The fastener 1005 can include at least one sharp portion or end (e.g., point, threads, etc.) that can extend through, cut away, or pierce a non-conductive coating of the housing 205 of the battery pack 110 to facilitate forming a conductive pathway. For example, the fastener 1005 can be a thread forming or E-coat clearing fastener. For example, the conductive pathway can extend from the header 305 (e.g., the spring features 310), to the plate 405, to the line 805, to the fastener 1005, to the housing 205. As described herein, the housing 205 can be grounded with a portion of the vehicle 105 (e.g., the chassis 125) such that the plate 405 facilitates grounding the header 305 with the chassis 125 of the vehicle 105 and with the battery pack 110 (e.g., providing a pathway for electrical current to flow between conductive materials).

The apparatus 220 can include various amounts of plates 405 or headers 305. For example, as depicted in at least FIG. 7, the apparatus 220 can include one plate 405 that couples with multiple (e.g., two) headers 305. For example, the plate 405 can couple with a first header 305 and a second header to couple the conductive path with both the first header 305 and the second header 305. As depicted in at least FIG. 12, the apparatus 220 can include one or more plates 405 that each couple with one respective header 305. For example, the apparatus 220 can include a first plate 405 that couples with a first header 305 or a second plate 405 that couples with a second header 305. The first plate 405 can couple the first header 305 with a first line 805 and the second plate 405 can couple the second header 305 with a second line 805.

In some implementations, the plate 405, the fastener 1005, or another portion of the apparatus 220 can contact a portion of the chassis 125 of the vehicle 105 directly (e.g., with or without contacting the housing 205 of the battery pack 110).

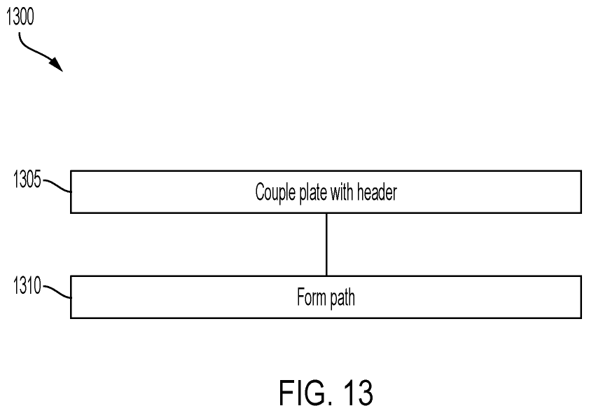

FIG. 13 depicts an example illustration of a method 1300. The method 1300 can include coupling a plate 405 with a header 305, as depicted in act 1305. For example, the plate 405 can receive and couple with one or more headers 305 via one or more apertures 415 and fasteners 605, as depicted in at least FIGS. 3-7. As another example, the plate 405 can couple with a header 305 by at least partially surrounding the header 305. As described herein, the plate 405 can include at least one feature that biases or protrudes towards a spring feature 310 of the header 305. For example, the plate 405 can include at least one protrusion 425 that contacts a spring feature 310 of a header 305, as depicted in at least FIGS. 3-7. As another example, the plate 405 can be or can include a tab that protrudes towards and contacts at least one spring feature 310 of the header 305, as depicted in at least FIGS. 8-12.

The method 1300 can include coupling the plate 405 with a conductive path to form the conductive path, as depicted in act 1310. For example, the plate 405 can couple with at least one piercing element 430. The piercing element 430 can couple with the plate through welding, conductive adhesives, or fasteners, or the piercing element 430 can be monolithically formed with the plate 405. The piercing element 430 can cut away a non-conductive coating of the housing 205 of the battery pack 110 to contact at least a portion of a conductive wall (e.g., front wall) of the housing 205. As another example, the plate 405 can couple with a line 805 (e.g., ground wire) formed of at least one conductive material. The line 805 can contact at least a portion of a fastener 1005 that is coupled with a battery pack 110 to facilitate grounding the header 305 with the battery pack 110.

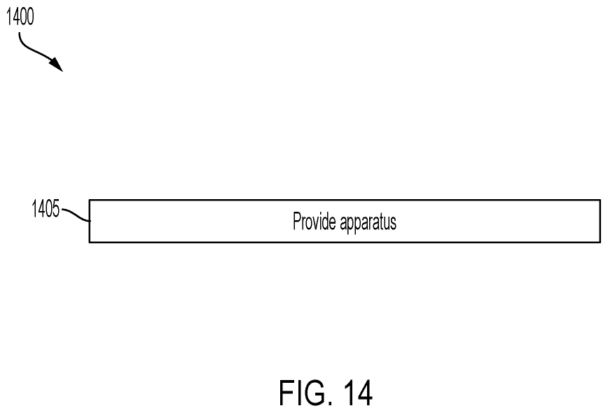

FIG. 14 depicts an example illustration of a method 1400. The method 1400 can include providing a header apparatus 220, as depicted in act 1405. The header apparatus 220 can include at least one header 305. The header 305 can be formed of at least one non-conductive material (e.g., plastic). The header 305 can include one or more metallic materials or other at least partially conductive materials. For example, the header 305 can include at least one spring feature 310. The spring features 310 can be or can include one or more conductive materials that protrude or bias at least partially outward from the header 305.

The header apparatus 220 can include at least one plate 405. The plate 405 can be or can include one or more conductive materials. For example, the plate 405 can be made of one or more metals (e.g., aluminum, steel, etc.). The plate 405 can include at least one slot 410 (e.g., hole, aperture, etc.) that can at least partially receive a header 305, as depicted in at least FIGS. 4 and 5. The plate 405 can at least partially surround a header 305 on an internal portion of the battery pack 110, as depicted in at least FIGS. 11 and 12.

The plate 405 can include at least one gasket 420. For example, each slot 410 can include a gasket 420 (e.g., a die cut gasket) that at least partially surrounds the slot 410 and facilitates sealing the header 305 with the housing 205 of the battery pack 110. The gaskets 420 can include an adhesive backing to facilitate forming a seal of the header 305 with the housing 205 of the battery pack 110. For example, the gaskets 420 can be positioned to couple between the header 305 or plate and the battery pack 110 such that the gasket 420 at least partially engages the battery pack housing 205 (e.g., when a fastener extending through the apertures 315, 415 connects to the battery pack 110 and facilitates compressing the gasket 420 between the plate 405 and the battery pack 110). The plate 405 can include at least one gasket 420 positioned at or near a location of a seal of each respective header 305.

The plate 405 can include at least one conductive feature that facilitates coupling the header 305. For example, the plate 405 can include at least one protrusion 425 at or near the slot 410. The protrusion 425 can be formed of at least one conductive material (e.g., metals such as aluminum or steel). The protrusion 425 can extend from the plate 405 to engage (e.g., contact) at least a portion of at least one of the spring features 310 of the header 305 to form a conductive pathway between the spring features 310 and the plate 405 (e.g., via contact between the spring features 310 and the protrusion 425). For example, the protrusion 425 can establish an electrical connection with the spring feature 310 such that electrical current can flow between the spring feature 310 and the protrusion 425.

The plate 405 can include at least one piercing element 430 that can facilitate at least partially piercing (e.g., cutting, breaking through, digging) through at least a portion of a non-conductive coating of the housing 205 of the battery pack 110. The piercing element 430 can be a protrusion or extension of the plate 405 that at least partially extends away from a surface of the plate 405. The piercing elements 430 can include at least one sharp edge (e.g., a pointed edge, a triangular edge, a tooth-like edge, a serrated edge, a saw tooth edge, etc.). The sharp edge of the piercing elements 430 can facilitate piercing at least a portion of the battery pack 110. The apparatus 220 can facilitate defining a conductive pathway between the header 305 (e.g., by the spring features 310), the plate 405 (e.g., by the protrusion 425 and the piercing element 430), and the battery pack 110 (e.g., by the piercing element 430 cutting away a non-conductive coating of the battery pack housing 205 and contacting at least a portion of conductive material of the housing 205). The battery pack 110 can be conductively coupled to another portion of the vehicle 105 (e.g., the chassis 125) such that the apparatus 220 can facilitate grounding the header 305 with the chassis 125 or another portion of the vehicle 105.

The plate 405 at least partially surrounding the header 305 and at least partially protruding towards and contacting a spring feature 310 can couple with (e.g., contact) at least one conductive pathway (e.g., line 805), as depicted in at least FIG. 8. For example, the conductive line 805 can be or include a wire, cable, or other line formed of a conductive material. The line 805 can couple with the plate 405 in various ways including, but not limited to, welding, fasteners, conductive adhesives, or other means. The plate 405 can at least partially couple with one or more busbars. For example, the line 805 can be a ground neutral (GND) wire or overmolded ground busbar that connects to the header 305.

The line 805 can couple with and at least partially contact a fastener 1005. The fastener 1005 can be or include a cutting fastener (e.g., screw), bolt, clip, tab, clamp, or other feature that can couple with a portion of the battery pack 110. The fastener 1005 can include at least one conductive material. The fastener 1005 can include at least one sharp portion or end (e.g., point, threads, etc.) that can extend through, cut away, or pierce a non-conductive coating of the housing 205 of the battery pack 110 to facilitate forming a conductive pathway. For example, the fastener 1005 can be a thread forming or E-coat clearing fastener. The apparatus 220 can facilitate defining a conductive pathway between the header 305 and the battery pack 110. For example, the conductive pathway can extend from the header 305 (e.g., the spring features 310), to the plate 405, to the line 805, to the fastener 1005, to the housing 205. As described herein, the housing 205 can be grounded with a portion of the vehicle 105 (e.g., the chassis 125) such that the plate 405 facilitates grounding the header 305 with the chassis 125 of the vehicle 105 and with the battery pack 110 (e.g., providing a pathway for electrical current to flow between conductive materials).

While operations are depicted in the drawings in a particular order, such operations are not required to be performed in the particular order shown or in sequential order, and all illustrated operations are not required to be performed. Actions described herein can be performed in a different order.

Having now described some illustrative implementations, it is apparent that the foregoing is illustrative and not limiting, having been presented by way of example. In particular, although many of the examples presented herein involve specific combinations of method acts or system elements, those acts and those elements may be combined in other ways to accomplish the same objectives. Acts, elements and features discussed in connection with one implementation are not intended to be excluded from a similar role in other implementations or implementations.

The phraseology and terminology used herein is for the purpose of description and should not be regarded as limiting. The use of “including” “comprising” “having” “containing” “involving” “characterized by” “characterized in that” and variations thereof herein, is meant to encompass the items listed thereafter, equivalents thereof, and additional items, as well as alternate implementations consisting of the items listed thereafter exclusively. In one implementation, the systems and methods described herein consist of one, each combination of more than one, or all of the described elements, acts, or components.

Any references to implementations or elements or acts of the systems and methods herein referred to in the singular may also embrace implementations including a plurality of these elements, and any references in plural to any implementation or element or act herein may also embrace implementations including only a single element. References in the singular or plural form are not intended to limit the presently disclosed systems or methods, their components, acts, or elements to single or plural configurations. References to any act or element being based on any information, act or element may include implementations where the act or element is based at least in part on any information, act, or element.

Any implementation disclosed herein may be combined with any other implementation or embodiment, and references to “an implementation,” “some implementations,” “one implementation” or the like are not necessarily mutually exclusive and are intended to indicate that a particular feature, structure, or characteristic described in connection with the implementation may be included in at least one implementation or embodiment. Such terms as used herein are not necessarily all referring to the same implementation. Any implementation may be combined with any other implementation, inclusively or exclusively, in any manner consistent with the aspects and implementations disclosed herein.

References to “or” may be construed as inclusive so that any terms described using “or” may indicate any of a single, more than one, and all of the described terms. References to at least one of a conjunctive list of terms may be construed as an inclusive OR to indicate any of a single, more than one, and all of the described terms. For example, a reference to “at least one of ‘A’ and ‘B’” can include only ‘A’, only ‘B’, as well as both ‘A’ and ‘B’. Such references used in conjunction with “comprising” or other open terminology can include additional items.

Where technical features in the drawings, detailed description or any claim are followed by reference signs, the reference signs have been included to increase the intelligibility of the drawings, detailed description, and claims. Accordingly, neither the reference signs nor their absence have any limiting effect on the scope of any claim elements.

Modifications of described elements and acts such as variations in sizes, dimensions, structures, shapes and proportions of the various elements, values of parameters, mounting arrangements, use of materials, colors, orientations can occur without materially departing from the teachings and advantages of the subject matter disclosed herein. For example, elements shown as integrally formed can be constructed of multiple parts or elements, the position of elements can be reversed or otherwise varied, and the nature or number of discrete elements or positions can be altered or varied. Other substitutions, modifications, changes and omissions can also be made in the design, operating conditions and arrangement of the disclosed elements and operations without departing from the scope of the present disclosure.

For example, descriptions of positive and negative electrical characteristics may be reversed. For example, any component of the apparatus depicted in FIGS. 3-7 can be apparent in the apparatus depicted in FIGS. 8-12. Similarly, any component of the apparatus depicted in FIGS. 8-12 can be apparent in the apparatus depicted in FIGS. 3-7. Elements described as negative elements can instead be configured as positive elements and elements described as positive elements can instead by configured as negative elements. For example, elements described as having first polarity can instead have a second polarity, and elements described as having a second polarity can instead have a first polarity. Further relative parallel, perpendicular, vertical or other positioning or orientation descriptions include variations within +/−10% or +/−10degrees of pure vertical, parallel or perpendicular positioning. References to “approximately,” “substantially” or other terms of degree include variations of +/−10% from the given measurement, unit, or range unless explicitly indicated otherwise. Coupled elements can be electrically, mechanically, or physically coupled with one another directly or with intervening elements. Scope of the systems and methods described herein is thus indicated by the appended claims, rather than the foregoing description, and changes that come within the meaning and range of equivalency of the claims are embraced therein.

What is claimed is:

1. An apparatus, comprising:
a plate to couple with a non-conductive header of a battery pack; and
the plate to form a conductive path between the header and the battery pack.

2. The apparatus of claim 1, comprising:
the plate comprising a piercing element that at least partially protrudes from the plate; and
the piercing element to at least partially extend beyond a non-conductive coating of the battery pack to form the conductive path.

3. The apparatus of claim 1, comprising:
the conductive path comprising a wire configured to couple with a fastener coupled with the battery pack; and
the fastener to at least partially extend beyond a non-conductive coating of the battery pack.

4. The apparatus of claim 1, comprising:
the header comprising a feature having at least one conductive material; and
the plate comprising an aperture configured to receive the header and a protrusion to at least partially contact the feature to facilitate forming the conductive path.

5. The apparatus of claim 1, comprising:
the header comprising a feature having at least one conductive material; and
the plate configured to at least partially contact the feature to facilitate forming the conductive path.

6. The apparatus of claim 1, comprising:
the header to couple with a front wall of the battery pack.

7. The apparatus of claim 1, comprising:
the plate to couple with a second header of the battery pack; and
the plate to form the conductive path between the second header and the battery pack.

8. The apparatus of claim 1, comprising:
a second plate to couple with a second header of the battery pack; and
the second plate to form a conductive path between the second header and the battery pack.

9. A battery pack, comprising:
an apparatus, comprising:
a plate to couple with a non-conductive header of the battery pack; and
the plate to form a conductive path between the header and the battery pack.

10. The battery pack of claim 9, comprising
the plate comprising a piercing element that at least partially protrudes from the plate; and
the piercing element to at least partially extend beyond a non-conductive coating of the battery pack to form the conductive path.

11. The battery pack of claim 9, comprising:
the conductive path comprising a wire configured to couple with a fastener coupled with the battery pack; and
the fastener to at least partially extend beyond a non-conductive coating of the battery pack.

12. The battery pack of claim 9, comprising:
the header comprising a feature having at least one conductive material; and
the plate comprising an aperture configured to receive the header and a protrusion to at least partially contact the feature to facilitate forming the conductive path.

13. The battery pack of claim 9, comprising:
the header comprising a feature having at least one conductive material; and
the plate configured to at least partially contact the feature to facilitate forming the conductive path.

14. The battery pack of claim 9, comprising:
the header to couple with a front wall of the battery pack.

15. The battery pack of claim 9, comprising:
the plate to couple with a second header of the battery pack; and
the plate to form the conductive path between the second header and the battery pack.

16. The battery pack of claim 9, comprising:
a second plate to couple with a second header of the battery pack; and
the second plate to form a conductive path between the second header and the battery pack.

17. A method comprising:
coupling a plate with a non-conductive header of a battery pack; and
forming, by the plate, a conductive path between the header and the battery pack.

18. The method of claim 17, comprising:
the plate comprising a piercing element that at least partially protrudes from the plate; and
the piercing element to at least partially extend beyond a non-conductive coating of the battery pack to form the conductive path.

19. The method of claim 17, comprising:
the conductive path comprising a wire configured to couple with a fastener coupled with the battery pack; and
the fastener to at least partially extend beyond a non-conductive coating of the battery pack.

20. The method of claim 17, comprising:
the header comprising a feature having at least one conductive material; and
the plate configured to at least partially contact the feature to facilitate forming the conductive path.
